(19) United States
(12) Patent Application Publication
(10) Pub. No.: US 2008/0128219 A1
(43) Pub. Date: Jun. 5, 2008

(54) Method of Transporting Persons in a Building

(76) Inventors: Lukas Finschi, Lucerne (CH); Paul Friedli, Remetschwil (CH)

Correspondence Address: Klaus P Stoffel;Wolff & Samson, One Boland Drive, West Orange, NJ, 07052, US

(21) Appl. No.: 11/792,215

(22) PCT Filed: Nov. 28, 2005
(86) PCT No.: PCT/CH05/00705

§ 371 Date: Jun. 26, 2007

(30) Foreign Application Priority Data
Dec. 1, 2004 (EP) 04106222.5

(51) Int. Cl. B66B 1/14; B66B 1/18

(52) U.S. Cl. 187/384

(57) ABSTRACT

The invention relates to a method and an arrangement for transporting people in a building by means of a lift installation (10) comprising at least one lift cage (11). Said lift cage (11) is entered by people on at least one first or one second access floor (S1, S2). In order to increase the transport efficiency, at least one target floor (S3, S4, 55, S6, S7) is associated with each access floor (S1, S2) in a fixed manner, in such a way that the lift cage (11) travels from the first access floor (S1) to the associated first target floor (S4, S5), and from the second access floor (S2) to the associated second target floor (S5, (56, S7).

The invention relates to a method of transporting persons in a building by means of a lift installation, which comprises at least one lift cage, wherein the lift cage is entered by persons at least one first or at a second access storey. The invention further relates to an arrangement for transporting persons in a building with at least one lift installation, which comprises at least one lift cage, wherein at least two access storeys are provided.

Lift installations for transporting persons are used in modern high-rise buildings. The persons are usually transported at similar starting times by a lift installation to the respective work or office storeys or at similar end times back to the access storeys. Due to the high loading of the lift installations at these times use is made of complicated lift control programs in order to increase effectiveness in the transport of persons. For example, a destination call control is used by way of which a passenger inputs his or her travel destination by means of an input device. A lift control then assigns a lift cage to the appropriate person on the basis of the desired destination storey. It is thus achieved that persons having common destination storeys are concentrated in the lift cage so that the travel time of the lift cage is not prolonged by numerous intermediate stops.

A control device for controlling a lift installation with a multiple cage is known from EP 1 418 147 A1. The multiple cage has several cage decks which are simultaneously accessible at a main stopping point by way of several main stopping planes. Two storeys of a building can be simultaneously served by the multiple cage with one stop. A call registration device by means of which a passenger can input his or her desired destination storey is provided at the main stopping point. In order to enable more rapid filling of the building and to minimise the number of intermediate stops of the multiple cage there is provided a computing unit constructed for the purpose of ascertaining, on the basis of the destination call input of the passenger at the main stopping point and on the basis of already allocated and/or placed travel requests, which cage deck of the multiple cage is to be assigned to the passenger at the main stopping point. The passenger is thus assigned to a plane, which corresponds with his or her destination call input, enabling effective transport of persons by means of the multiple cage. After input of the destination call the passenger must then go to the corresponding plane in order to enter the multiple cage at the appropriate plane.

The assignment of persons to multiple cages by means of a destination call control and even the assignment of persons to single lift cages by means of a destination call control require a complex control. Notwithstanding this destination call control, delays in the transport of persons occur particularly at peak times since, for example, persons who have not input a destination call board lift cages.

Against this background the object of the present invention arises as indication of a method and an arrangement for transport of persons in buildings in which the number of intermediate stops at storeys of a building is minimised and shorter travel times are achievable.

The invention is based on the concept that modern office buildings usually have several access storeys. If several access storeys by way of which the building is opened up are present, the performance capability of the lift installation can be increased if at least one destination storey is allocated to each access storey. In the case of the design according to the invention the lift cage travels from a first access storey to at least one fixedly allocated first destination storey. Equally, a lift cage travels from a second access storey to at least one fixedly allocated second destination storey, which in principle differs from the first destination storey. According to the invention persons can be so guided to the access storeys that they are transported from an access storey to the allocated destination storey without an intermediate stop. Through guidance of persons to the respective correct access storeys, persons with the same destination storey enter the lift cage at the same access storey. From there the lift cage travels directly to the corresponding destination storey.

By contrast to the assignment, which is known from the state of the art, of lift cages by means of destination call control here there takes place guidance of persons to access storeys with fixed destination storeys.

Thus it is ensured that, for example, the employees of a relevant company who daily travel to the same destination storey always enter the lift cage at the same access storey and travel from there to their destination storey. Persons of another company based in a different storey use another access storey from which a lift cage travels to the destination storey at which the other company has its offices. Transport in the lift cages to further storeys takes place without intermediate stops.

In a simple embodiment the invention can be performed already with a lift cage which travels, in particular at appropriate times, from a first access storey to a first fixedly allocated destination storey and from a second access storey to a second fixedly allocated destination storey, wherein the first and second destination storeys are different from one another. Thus, persons with the same destination storeys are guided to the same access storeys whereby travel times of the lift cages are significantly reduced.

An efficient transport of persons is thereby made possible particularly at peak times. Flows of persons can be guided by the method according to the invention, wherein the several access storeys are effectively utilised. There is avoidance of the situation that all persons who would like to be transported in this building wait for a lift cage at a single access storey and have to be assigned the lift cages depending on destination call inputs. In addition, there is avoidance of the situation there persons not only of the first company, but also of the second company board the lift cages at the first and second access storey and travel from there to their destination storeys. In this case the lift cage would have to stop not only at the first, but also at the second access storey, and also at the first and second destination storey. It is more effective, particularly if two lift cages are provided for transportation, to let a lift cage travel from the first access storey directly to the first destination storey and the second lift cage to travel from the second access storey to the second destination storey. The sole precondition for effective transportation is in this connection is that persons board the lift cages at the correct access storeys.

Advantageous embodiments of the invention can be inferred from the subclaims.

In a special refinement of the invention it is possible that a first group of destination storeys is fixedly allocated to a first access storey and a second group of destination storeys is fixedly allocated to a second access storey. In that case the first and second groups can essentially comprise different destination storeys. However, it is also possible that the first and second groups of destination storeys go to a common storey, for example a changeover storey. A reduction in the possible intermediate stops is thus achieved, whereby the travel time is minimised. Allocation of groups of destination storeys to one access storey is useful particularly when companies have offices in several storeys. Thus, persons have in this access storey only the possibility of selecting between the destination storeys of the group to which the company and thus this access storey are allocated.

It is particularly advantageous if the assignment of persons to the first or second access storey is undertaken in accordance with the respective destination storeys of persons by a building control unit independently of a lift control.

For example, indicator boards can be used which illustrate the fixed allocation of destination storeys to the respective access storeys. Persons who want a first company can read off the respective access storey and go there. This is particularly advantageous if the allocation of the destination storeys to the access storeys is variable so that employees of companies have to reorientate themselves on a daily basis with regard to from which access storey a lift cage travels to their destination storey. In the case of non-variable allocation of the destination storeys to the access storeys the assignment or guidance of persons to the access storeys can be effected by a permanent inscription in the building.

In a special embodiment of the invention an access authorization to an access storey is checked by the building control unit. It can thus be ensured that persons without access authorization do not get to the respective access storey. The building control unit can allocate and indicate the respective access storey to the persons in dependence on their access authorization. In this connection the terms “storey” and “access storey” have a general meaning and signify an access region or a lobby located at the side of a door.

Checking of the access authorization can be undertaken by means of, for example, a wireless transmission of an access code which is stored on an identification card. Persons carry the identification cards. The access code on entry into the building is interrogated by the building control unit either wirelessly or on a contact basis through introduction into a reader. The access authorization is determined in dependence on the access code. If an access authorization is present, a door or a barrier is opened which frees access to an access storey. It is also possible to input an access code by means of an input apparatus in order to obtain access to an access storey. For that purpose a person inputs his or her destination call or access code into the input apparatus, wherein there is shown on a display the respective access storey from which a lift cage travels directly to the desired destination storey. It is thus possible to grant persons restricted access to public storeys. On input of a non-public destination storey, access is denied. If, thereagainst, the person inputs a permissible destination call for a public destination storey, access is made possible to the access storey from which a lift cage travels to the public destination storeys. The access authorization can also be carried out in functional manner. Physical access is denied not by a door or a barrier, but the lift cannot be called without authorization. The lift door itself in this case represents the physical barrier.

A co-ordination of the individual flows of persons can be undertaken in that the access authorization is, for example, interrogated before the respective persons enter the access storey. After determination of the access authorization exactly the door or barrier is opened which leads to the access storey to which the respective person is authorised for access.

Flows of persons can be efficiently co-ordinated by the method according to the invention so that, for example, persons who want a restaurant in the uppermost floor input the destination call ‘Restaurant’ on entry into the building and then there is allocated an access storey from which a lift cage travels directly to the storey in which the restaurant is located. Other destination storeys cannot be reached by restaurant visitors.

Beyond that it is also possible that after successful checking of the access authorization to an access storey the person having an appropriate form of access authorization can change the destination storey in the lift cage. It is thus ensured that persons with special access authorization (VIPs) after entry into a lift cage not only are transported to the fixedly allocated destination storey, but can also go to other destination storeys.

The method according to the invention can be used particularly efficiently if the lift installation has several lift cages, wherein a first lift cage serves the first access storey and a second lift cage serves the second access storey. If beyond that still further lift cages are arranged in the lift installation for transport of persons it is possible that several lift cages travel from one access storey fixedly to one destination storey or that there is provided an additional lift cage for the transport of persons to other destination storeys for which no fixed allocation is present.

In a preferred embodiment of the invention the destination storeys are fixedly allocated to the access storeys only at specific times. The fixed allocation of destination storeys to the access storeys is offered particularly at peak times in order to efficiently cover the increased transport requirement. Between peak times all destination storeys in the building can be reached by the lift cage.

In a preferred refinement of the invention it is possible to use the fixed allocation of destination storeys to the access storeys in combination with a destination call control. This variant offers itself particularly when several lift cages are present which serve a group of fixedly allocated destination storeys.

In the case of an arrangement according to the invention for the transport of persons in a building with a lift installation the lift installation comprises at least one lift cage, wherein at least two access storeys are provided and at least one respective destination storey is allocated to each of the destination storeys.

In an advantageous embodiment it is provided that a building control unit undertakes the assignment or guidance of persons to access storeys in accordance with their destination storeys, wherein the building control unit is advantageously coupled with access terminals. The access terminals can be constructed as part of the building control unit. The access terminals receive an access code in wire-free manner, on a contact basis or by user input. An access authorization is determined from this access code directly in the access terminal or in the building control unit and an access storey is displayed to the person or access is granted to the corresponding access storey.

In a further advantageous embodiment there is provided at least one access barrier in the form of a door or barrier which is opened or closed in dependence on the access authorization.

In addition, an indicating device for indication of an association of the destination storeys to the access storeys is preferably provided. The indicating device can be constructed in the form of a display in order to indicate a variable allocation of access storeys to destination storeys. The indicating device can, however, also be constructed as a simple information panel in the case of a fixed allocation.

In a special refinement of the invention lift cages with several part cages separate from one another are used in order to achieve efficient transport of persons. For this purpose the lift cage is, for example, divided vertically or horizontally. In the case of a vertical separation of the lift cage the lift cage can be entered from two sides, wherein the part cage able to be entered from one side of the access storey travels to a specific destination storey and the part cage able to be entered from the other side of the access storey travels to the respective other side of the destination storey, wherein the respective sides of the access and destination storeys are separate from one another. Similarly, it is possible to divide a lift cage horizontally into an upper and a lower part cage. Thus, persons who enter the lower part cage by way of a lower access storey are transported to a lower destination storey. Persons who enter the upper part cage at an upper access storey are transported by the same lift cage to a destination storey arranged exactly one storey above the lower destination storey. It is thus ensured that persons are transported without disturbance by one another.

The invention is explained in more detail in the following on the basis of examples of embodiment, which are illustrated in schematic manner in drawings, in which:

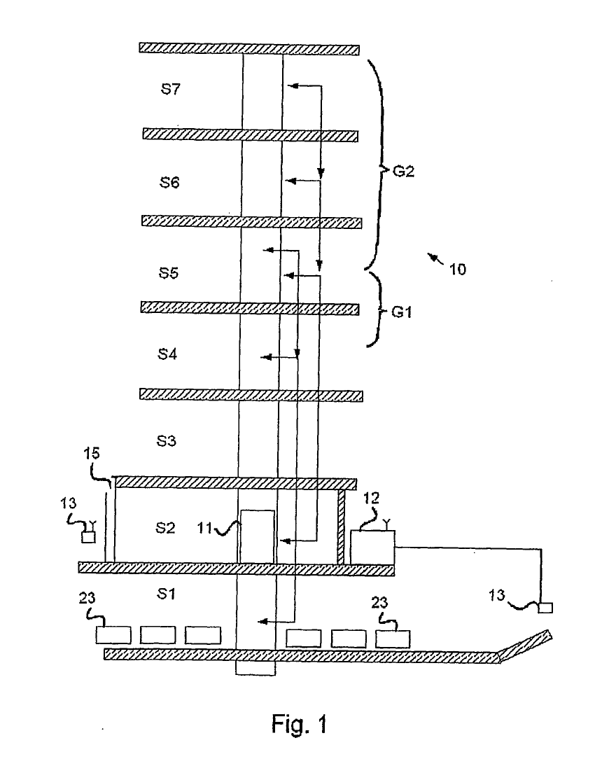

FIG. 1 shows a schematic illustration of a lift installation according to the present invention;

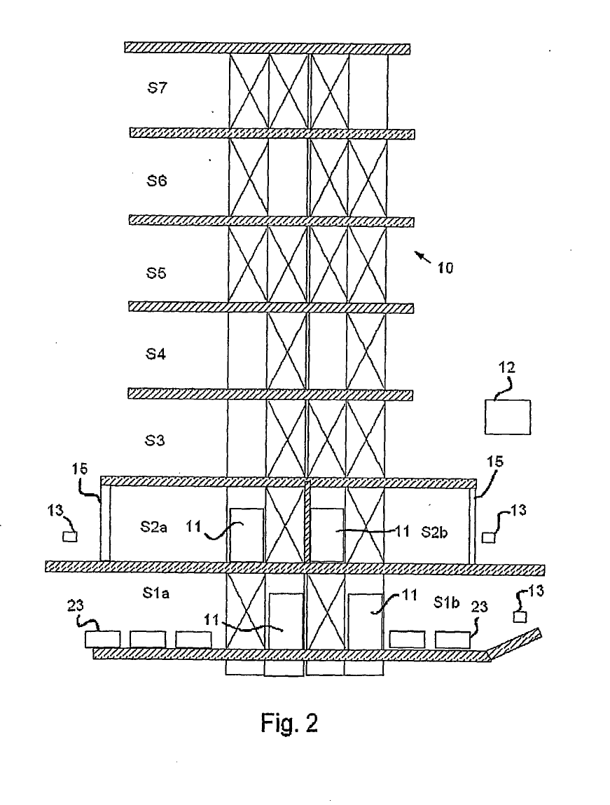

FIG. 2 shows a schematic illustration of an alternative lift installation according to the present invention;

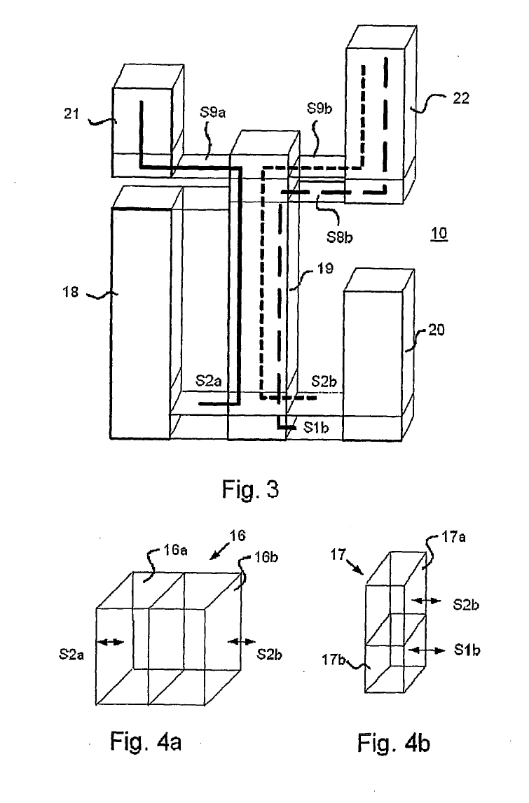

FIG. 3 shows a schematic illustration of a further alternative embodiment according to the present invention;

FIG. 4a shows a lift cage with vertical division;

FIG. 4b shows a lift cage with horizontal division;

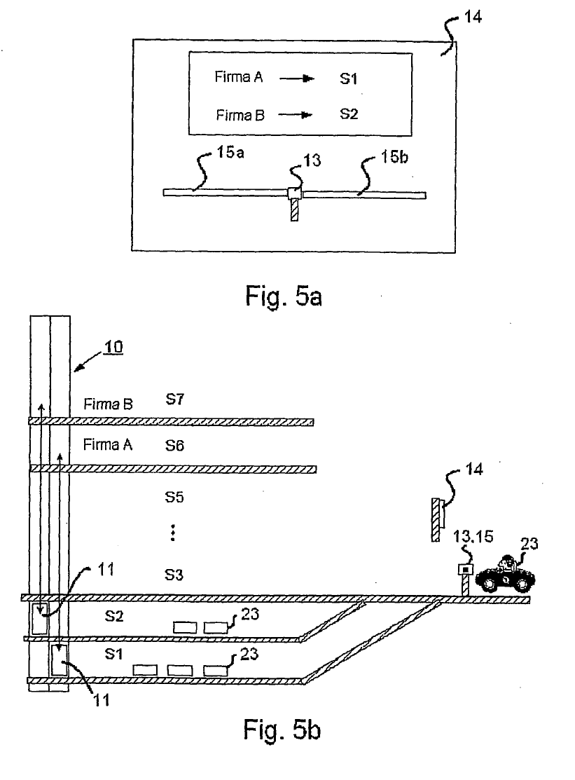

FIG. 5a shows a schematic illustration for guidance of persons and a display of access storeys, according to the present invention; and

FIG. 5b shows a schematic illustration of a lift installation and the guidance of persons according to the present invention.

A schematic illustration of a building with a lift installation 10 and with seven storeys is shown in FIG. 1. Of those, the storeys S1 and S2 are developed as access storeys and the storeys S4 to S7 as destination storeys. A lift cage 11 is moved in the lift installation 10 in order to transport persons from the respective access storeys S1 and S2 to a destination storey S4, S5, S6 or S7. The access storey S1 is an underground garage to which vehicles 23 of the persons go after they have identified their access authorization at an access terminal 13. Persons boarding the lift cage 11 in the underground garage or the access storey S1 are transported either to the destination storey S4 or to the destination storey S5. Persons who enter the lift cage 11 at the access storey S2 are transported to the destination storey S5, S6 or S7. Access to the access storey S2 is blocked by a door 15 which is opened only after checking of an access authorization at an access terminal 13. The two access terminals 13 are coupled with a building control unit 12 either wirelessly via the indicated aerials or by way of a connecting line. A first group G1 of destination storeys, which comprises the destination storeys S4 and S5, can be reached from the first access storey S1. A group G2 with the destination storeys S5, S6 and S7 is allocated to the second access storey S2.

An alternative embodiment of a lift installation 10 for use of the method according to the invention is illustrated in FIG. 2. The lift installation 10 according to FIG. 2 has four lift cages 11 arranged for the transportation of persons. The lift installation 10 comprises four separate access storeys S1a, S1b, S2a and S2b. Persons entering the lift cage 11 at the access storey S1a are transported to the destination storey S6. Persons entering the lift cage 11 at the access storey S1b are transported to the destination storey S7. Persons entering the lift cage 11 at the second access storey S2a are transported to the destination storeys S3 and S4. Thereagainst, persons entering the lift cage 11 on the other side of the second destination storey S2b are transported only to the destination storey S4. The respective access storeys S1a, S1b, S2a and S2b are opened for access by way of doors or barriers 15 in each instance only after checking of the access authorization at an access terminal 13. Destination storeys S4, S5, S6 and S7 which cannot be moved to by individual lift cages 11 are provided with a large cross. There are also destination storeys S5 which are accessible by way of other lift installations (not illustrated) or only by way of stairs. Destination storeys S5 of that kind are, for example, reachable only by a manual lift cage control, for example, in the case of use as a store or safety area without appreciable traffic of persons.

A further alternative embodiment of the lift installation 10 is explained in FIG. 3 in conjunction with FIGS. 4a and 4b. The lift installation 10 illustrated in FIG. 3 comprises several lift shafts 18, 19, 20, 21 and 22. The lift shaft 19 arranged in the middle serves for the distribution of persons within the building to so-termed destination or changeover storeys S8b, S9a and S9b. Several lift cages 11, which are not illustrated, are moved in the lift shaft 19. In that case use can be made of not only separate lift cages 11, but also multiple lift cages 16, 17, which are vertically divided into two separate part cages 16a and 16b, as is illustrated in FIG. 4a. It is also possible to horizontally divide a multiple cage 17 into two part cages 17a and 17b. In the case of use of a horizontally divided multiple cage 17 persons entering the part cage 17b from the first access storey S1b are transported to the destination or changeover storey S8b. Persons entering the part cage 17a at the access storey S2b are conveyed to the destination or changeover storey S9b separately from the persons from the access storey S1b. It is possible to make one of the access storeys S1b or S2b accessible for authorised persons (VIPs) who are then transported to a different destination storey S8b or S9b separately from other persons and without coming into contact with the other persons, either in the lift or at changeover storeys. This is conceivable, for example, for transporting executives or board members.

In the case of a vertically separated multiple cage 16 according to FIG. 4a persons entering the part cage 16a at the access storey S2a are transported to the destination or changeover storey 9a and can travel there by a lift cage 11 in the lift shaft 21 to the region of their office. Persons boarding the part cage 16b from the opposite access storey S2b are transported to a different destination and changeover storey 9b and can travel by a lift cage 11 in the other lift shaft 22 to another office region of the building. Thus, for example, employees of a company A can be assigned a separate part cage 16a transporting exclusively employees of the company A, who in each instance are moved to the building region which is accessible from the lift shaft 21 and with which the company A is associated. Employees of the company B are transported from the access storey S2b separately to a building part which is opened up by the lift shaft 22.

The co-ordination, which is required for effective utilisation of a lift installation 10 according to FIG. 1, 2 or 3, of the visitor or person flows in a building is illustrated in FIGS. 5a and 5b. On entry into a building, an access authorization is initially checked by an access terminal 13, in that an access code is input or transmitted. The access code can be stored on an ID card or an entry card. Depending on the respective access authorization an access barrier 15, here in the form of a barrier 15a, 15b, opens as is illustrated in FIG. 5a. Depending on which access authorization is present, for example, the lefthand barrier 15a opens for the company A or the righthand barrier 15b for the company B. The allocation of the access storeys S1, S2 to the destination storeys S6, S7 is indicated on an indicating device 14. The employees of the company A are guided to the first access storey S1. Employees of the company B are guided to the second access storey S2, so that the employees are assigned to the access storeys S1, S2, from which they go to the fixedly allocated destination storeys S6, S7, solely by way of the guidance to the access storeys S1, S2 or parking levels.

Through the refinement according to the invention it is possible that the lift cage 11 has to serve only a small number of different travel destinations, whereby a higher performance capability of the lift installation 10 is achieved.

In the above-described examples of embodiment in each instance a fixed allocation of access storeys S1, S2 to destination storeys S4, S5, S6, S7 is illustrated. However, it is also possible in a simple embodiment that, for example, the lift cage 11 travels from the access storey S1 basically to the uneven-numbered destination storeys S3, S5, S7 and the lift cage 11 at the second access storey S2 travels to the even-numbered destination storeys S4 and S6.

The idea according to the invention can also be analogously transferred to other applications. In the case of restaurants which extend over several storeys the respective restaurant visitors can be assigned, already on driving into the parking building, to parking spaces, which correspond with their desired destination restaurant, for their vehicles 23. It is further possible to reach theatres or cinemas each time by way of an access storey, for which the parking spaces correspond with the respectively allocated destination storey, from which a lift cage travels directly to a theatre or to a desired cinema. For example, the access code to an access storey can be stored on the entrance ticket for a cinema visitor. On driving into a parking building the access code on the entry ticket is interrogated for the storey in which the cinema in which the desired film is shown is located. There is indicated to the visitor on an indicating device 14 the corresponding parking level or access storey S1, S2 from which a lift cage 11 travels directly to the storey with the cinema.

Through the refinement of the method and the arrangement, in accordance with the invention, for the transport of persons it is possible to enable a rapid journey to a specific travel destination, wherein only a small waiting time and a small destination time, i.e. the travel time to the destination, are necessary. Moreover, through the method according to the invention there is made possible travel with a lift cage 11 in which authorised persons (VIPs) go as quickly as possible to their travel destination without other passengers or without non-VIP passengers in the same lift cage 11.

1-16. (canceled)

17. A method of transporting persons in a building using an elevator installation, which comprises at least one elevator cage, comprising the steps of: entering the elevator cage by persons at least one first or second access storey; and fixedly allocating at least one destination storey to each access storey.

18. The method according to claim 17, including transporting persons boarding the elevator cage at the first access storey to a first fixedly allocated destination storey and transporting persons boarding the elevator cage at the second access storey to a second fixedly allocated destination storey.

19. The method according to claim 17, including guiding persons with a common destination storey to common access storeys.

20. The method according to claim 17, wherein the allocating step includes fixedly allocating a first group of destination storeys to the first access storey and fixedly allocating a second group of destination storeys to the second access storey.

21. The method according to claim 20, wherein the groups of destination storeys have common destination storeys.

22. The method according claim 17, including assigning persons to the first or second access storey in accordance with the respective destination storeys of the persons by a building control unit independently of an elevator control.

23. The method according to claim 22, including checking an access authorization to an access storey with the building control unit.

24. The method according to claim 23, wherein, after checking the access authorization to an access storey, the destination storey allocated to this access storey is changed depending on the type of access authorization.

25. The method according to claim 23, including assigning persons with a restricted access authorization to an access storey from which only restricted, fixedly allocated destination storeys can be reached.

26. The method according to claim 17, wherein the fixed allocation of destination storeys to access storeys is carried out in a time-dependent manner.

27. An arrangement for transporting persons in a building with an elevator installation, comprising: at least one lift cage; at least two access storeys; and at least one respective destination storey fixedly allocated to each of the access storeys.

28. The arrangement according to claim 27, and further comprising a building control unit provided for assignment of persons to the individual access storeys in accordance with the destination storey thereof.

29. The arrangement according to claim 28, and further comprising at least one access terminal which is coupled with the building control unit and provided for checking an access authorization of persons.

30. The arrangement according 29, and further comprising an access barrier provided for opening or closing an access storey depending on the access authorization.

31. The arrangement according to claim 27, and further comprising an indicating device for indicating an allocation of the destination storeys to the access storeys.

32. The arrangement according to claim 27, wherein the elevator cage comprises several part cages separate from one another.
